(19) United States
(12) Patent Application Publication
(10) Pub. No.: US 2016/0250919 A1
(43) Pub. Date: Sep. 1, 2016

(54) FILL LIMIT VENT VALVE FOR UREA TANK OF VEHICLE

(71) Applicant: Hyundai Motor Company, Seoul (KR)

(72) Inventor: In Kyu BAE, Jeonju-si (KR)

(73) Assignee: Hyundai Motor Company, Seoul (KR)

(21) Appl. No.: 14/863,159

(22) Filed: Sep. 23, 2015

(30) Foreign Application Priority Data
Feb. 26, 2015 (KR) 10-2015-0026980

(51) Int. Cl. B60K 15/035; F01N 3/28

(52) U.S. Cl. CPC B60K 15/03519; F01N 3/2896

(57) ABSTRACT

A fill limit vent valve for a urea tank of a vehicle may include a head section having a first inner space, a second inner space and an exhaust port, a first housing section and a second housing section each having an inflow hole so that air and urea flow into an inner space of the respective first and second housing sections in the urea tank, a floater to open and close a vent hole between the first housing section and the head section, a vent hole formed to allow communication between the first inner space of the head section and the inner space of the first housing section, and between the second inner space of the head section and the inner space of the second housing section, respectively, and a connection passage allow the inner space and the second space of the head section to communicate with each other.

### CROSS-REFERENCE TO RELATED APPLICATION

The present application claims priority to Korean Patent Application No. 10-2015-0026980 filed Feb. 26, 2015, the entire contents of which is incorporated herein for all purposes by this reference.

### BACKGROUND OF THE INVENTION

1. Field of the Invention

The present invention relates to a fill limit vent valve for a urea tank of a vehicle. More particularly, the present invention relates to a fill limit vent valve that can solve a problem in which urea flows out of an injection port due to an action of internal pressure of a urea tank when pulling out an injection gun from the urea injection port after filling the urea in the urea tank.

2. Description of Related Art

While issues related to environmental pollution emerge as socially important issues, exhaust gas regulations of internal combustion engine vehicles that use fossil fuel have become increasingly strict.

Especially, in the exhaust gas of diesel engine vehicles that use diesel fuel, such as buses and trucks, a large amount of nitrogen oxides (NOx) known as a cause substance of acid rain and respiratory disease are included. Thus, the exhaust gas regulatory standards for motor vehicles that are recently being applied or to be applied further strictly regulate the emission standards of nitrogen oxides.

In order to satisfy the emission standards, a method for reducing nitrogen oxides contained in the exhaust gas of a diesel engine by applying a selective catalytic reduction (SCR) system to a vehicle has been suggested.

The SCR system removes nitrogen oxides in the exhaust gas, by utilizing urea as a catalyst to reduce nitrogen oxides to nitrogen and water, and in order to reduce the nitrogen oxides, urea up to about 4% to 6% of the fuel usage is normally used.

Therefore, urea should be periodically filled in the same manner as filling the fuel to the vehicle, and for this reason, the diesel engine vehicles to which the SCR system is applied are equipped with a fuel tank and a urea tank.

At present, the SCR system is mainly applied to large vehicles, such as trucks, and in recent years, the scope of application has expanded to small cars and mid-size cars.

Since a driver should replenish urea to the urea tank water at the time of application expansion of the SCR system, the frequency of the injection of urea also increases, and a method of injecting the urea using an injection gun at a gas station, a method of directly injecting the urea by a driver or the like can be applied.

Meanwhile, FIG. 1 is a diagram showing a urea tank assembly in which the urea is stored in the vehicle to which the SCR system is applied, and as illustrated, the urea tank assembly is configured to include a urea tank 1 that stores the urea, a urea injection port 2 for injecting the urea, a urea line 3 that connects between the urea tank 1 and the urea injection port 2.

In the interior of the urea tank 1 are, a fill limit vent valve (FLVV) 5 that prevents urea of the rated capacity or more from being injected to prevent the over-injection of the urea, a urea pump 4 that pumps and supplies the urea stored in the urea tank 1 for injecting the urea.

Also, when injecting the urea after inserting an injection gun (not shown) into the urea injection port 2 for filling the urea, the urea injected by the injection gun is supplied to the urea tank 1 through the urea line 3.

The fill limit vent valve 5 is a valve that prevents the urea from being injected any more through the urea injection port 2 when a constant capacity (rated capacity) of urea injected to the urea injection port 2 is filled in the urea tank 1, and a floater for opening and closing a vent hole is installed inside the fill limit vent valve 5.

FIG. 2 is a diagram showing a conventional fill limit vent valve installed in the urea tank, the fill limit vent valve 5 includes a head section 6 that is mounted on the upper part of the urea tank 1 and has an exhaust port 7 for discharging the air introduced into the inner space through a vent hole (not shown) on one side, a housing section 8 that is integrally formed in the head section 6, has an inflow hole 9 formed to allow the air and the urea to flow into the inner space in the urea tank 1, and is located by being inserted into the upper inside of the urea tank 1, a floater 10 that is installed in the inner space of the housing section 8 so as to vertically move according to a liquid level height of the urea introduced from the urea tank 1 through the inflow hole 9, and a vent hole formed to allow the inner space of the head section 6 and the inner space of the housing section 8 to communicate with each other.

At this time, a position and a height of the fill limit vent valve 5, the inflow hole height of the housing section and the like are set so that the floater 10 can rise to a height capable of blocking the vent hole by the urea introduced into the inner space of the housing section 8 through the inflow hole 9, when the urea of the defied rated capacity is filled in the urea tank 1.

Moreover, since the capacity of urea expands when being frozen at sub-zero temperature (about −11° C.), a room for free space should be present within the urea tank 1 in consideration of the amount of volume expansion, and the rated capacity is determined in consideration of the free space.

In the fill limit vent valve 5 of the above configuration, when urea injected through the urea injection port 2 is filled in the urea tank 1 by a rated capacity, the floater 10 rises by the urea in the housing section 8 introduced through the inflow hole 9 to block the vent hole, thereby preventing the urea from being injected any more.

If the urea filled in the urea tank 1 does not reach the rated capacity, the urea does not flow into the housing section 8 of the fill limit vent valve 5 or the urea flows into the housing section at a low liquid level height so that floater 10 cannot block the vent hole.

At this time, the floater 10 is located below the housing section 8 and remains in the state of opening the vent hole, even when the urea flows into the housing section, if the liquid level height of the urea is low, the urea cannot raise the floater so as to block the vent hole, and thus, the vent hole is opened.

When the vent hole is opened in this way, since the air of the upper part of the urea liquid level in the urea tank 1 can exit through the inflow hole 9 of the housing section 8, the inner space of the housing section, the vent hole, the inner space of the head section 6 and the exhaust port 7, it is possible to inject the urea into the urea tank 1 using the urea injection port 2.

Meanwhile, when the liquid level height of the urea filled in the housing section 8 rises, the floater 10 moves upward, and after urea of the rated capacity is filled inside the urea tank 1, the floater 10 blocks the vent hole in the state of being raised by the urea filled in the inner space of the housing section 8.

When the urea is filled in the inner space of the housing section 8 in this way, since the floater 10 blocks the vent hole to prevent escape of the air, the urea is not injected into the urea tank 1 through the urea injection port 2 any more.

Meanwhile, as described above, after urea of the rated capacity is filled in the urea tank 1 through the urea injection port 2, the fill limit vent valve 5 is shut-off and the urea is not injected any more. Air is compressed on the upper side of the rated capacity line in the urea tank 1, and the static pressure is formed.

This pressure acts on the liquid level of the urea filled in the urea tank 1, and when pulling out the injection gun from the urea injection port 2 after filling the urea, there is a problem in which the urea present in the urea tank 1 or the urea line 3 flows out of the injection port 2 in the opposite direction due to the pressure.

In this way, when the urea flows out through the injection port after injection of the rated capacity, the urea contaminates the vehicle, and displeasure of the user occurs due to unpleasant odor caused by ammonia gas.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing an apparatus for improving urea injection characteristics capable of solving the conventional problem in which the urea flows out of the injection port due to the action of the internal pressure of the urea tank, when pulling out the injection gun from the urea injection port of the vehicle after urea of the rated capacity is filled into the urea tank.

According to various aspects of the present invention, a fill limit vent valve for a urea tank of a vehicle may include a head section having a first inner space, a second inner space and an exhaust port for discharging air flowing into the first inner space, a first housing section and a second housing section integrally formed in the head section, the first and second housing sections each having an inflow hole formed so that air and urea flow into an inner space of the respective first and second housing sections in the urea tank, and positioned by being inserted into the urea tank, a floater disposed in the inner space of the first housing section so as to vertically move according to a liquid level height of the urea introduced from the urea tank through each inflow hole and configured to open and close a vent hole between the first housing section and the head section according to a vertical movement position, a vent hole formed to allow communication between the first inner space of the head section and the inner space of the first housing section, and between the second inner space of the head section and the inner space of the second housing section, respectively, and a connection passage provided to allow the inner space and the second space of the head section to communicate with each other, in which the inflow hole of the first housing section may be formed at a height lower than the inflow hole of the second housing section.

The fill limit vent valve for the urea tank of the vehicle may further include a floater disposed in the inner space of the second housing section to vertically move according to the liquid level height of the urea introduced from the urea thank through the inflow hole, and configured to open and close the vent hole between the second housing section and the head section according to the vertical movement position.

The head section may include a flange that is fastened or fixedly coupled to an outer surface of the urea tank.

The head section may be fixed to a urea tank upper portion, and the first housing section and second housing section may be formed to extend integrally with the head section so as to be inserted to an inside in the urea tank upper portion.

The inflow hole of the first housing section may be formed at a height that allows the inflow of the urea enough to raise the floater to a vent hole blocking position inside the first housing when the urea of a defined rated capacity is filled in the urea tank.

The inflow hole of the second housing section may have a smaller size than the inflow hole of the first housing section.

The connection passage may have an internal diameter of 3.5 mm.

The connection passage may have an inner diameter of 3 mm to 4 mm.

Thus, according to the fill limit vent valve according to the present invention, when there is a state where the urea of rated capacity is filled in the urea tank, by including a separate air exhaust path for eliminating the static pressure of the liquid surface upper side of the urea filled in the urea tank, it is possible to solve a problem in which the urea flows out of the injection port as in the related art when pulling out the injection gun from the urea injection port after filling.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram showing a urea tank assembly that stores urea in the vehicle to which a SCR system is applied according to the related art.

FIG. 2 is a diagram showing a conventional fill limit vent valve installed in the urea tank according to the related art.

FIG. 3 is a diagram showing a state in which an exemplary fill limit vent valve according to the present invention is disposed.

FIG. 4 is a perspective view showing the exemplary fill limit vent valve according to the present invention.

FIG. 5 is a cross-sectional view of the exemplary fill limit vent valve according to the present invention.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The present invention provides a fill limit vent valve that is improved so as to be able to solve the problem in which the urea flows out of the injection port due to the action of the internal pressure of the urea tank, when pulling out the injection gun from the urea injection port of the vehicle after urea of the rated capacity is filled into the urea tank.

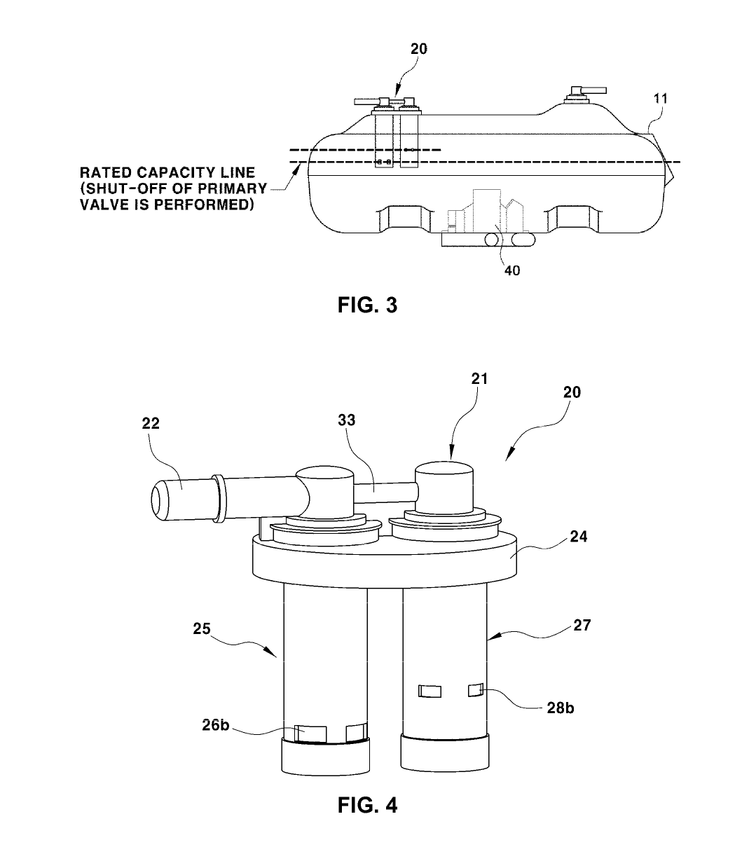

FIG. 3 is a diagram showing a state in which the fill limit vent valve according to various embodiments of the present invention is disposed, and FIG. 4 is a perspective view showing the fill limit vent valve according to various embodiments of the present invention.

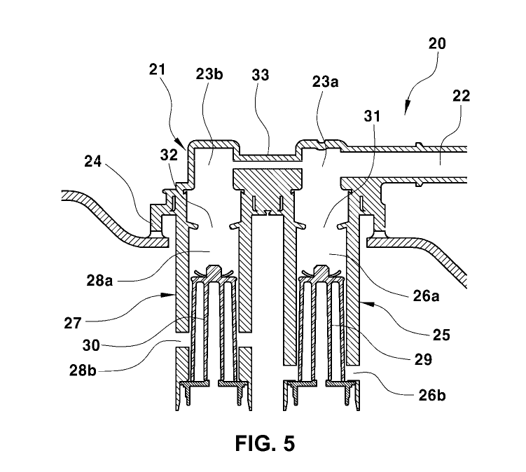

Further, FIG. 5 is a cross-sectional view of the fill limit vent valve according to various embodiments of the present invention.

As illustrated, the fill limit vent valve 20 includes an upper head section 21 having a first inner space 23a, a second inner space 23b and an exhaust port 22, a first housing section 25 and a second housing section 27 each having inflow holes 26b, 28b formed at different heights, floaters 29 and 30 that are each equipped in the first housing section 25 and the second housing section 27, vent holes 31, 32 through which the inner spaces 26a, 28a of the respective housing sections 25, 27 communicate with the inner spaces 23a, 23b of the head section 21, and a connection passage 33 through which the first inner space 23a and the second inner space 23b communicate with each other.

The fill limit vent valve 20 of the various embodiments of the present invention is mounted on the upper part of the urea tank 11, and the head section 21 has a flange 24 that is fastened or fixedly coupled to the upper outer surface of the urea tank 11.

Further, the head section 21 is formed integrally with the first housing section 25 and the second housing section 27, the flange 24 is disposed below the head section 21, and the first housing section 25 and the second housing section 27 are formed integrally on the lower surface of the flange 24.

Further, the head section 21 includes a first inner space 23a which communicates with the inner space 26a of first housing section 25 through the vent holes 31, and a second inner space 23b which communicates with the inner space 28a of the second housing section 27 through the vent hole 32, and the first inner pace 23a and the second inner space 23b are formed as spaces separated from each other.

On one side of the head section 21 formed with the first inner space 23a, an exhaust port 22 for discharging the air introduced into the first inner space to the outside is formed, and the first inner space 23a and the second inner space 23b of the head section 21 are formed as separate spaces from each other.

The connection passage 33 is a passage for connecting the first inner space 23a and the second inner space 23b of the head section 21. The first inner space 23a and the second inner space 23b communicate with each other by the connection passage 33 so that air introduced into the second inner space 23b of the head section 21 can move into the first inner space 23a.

Meanwhile, the first housing section 25 and the second housing section 27 are tubular sections extending long downward from the head section 21, the first housing section 25 and the second housing section 27 have inner spaces 26a, 28a of defined capacity, and the first housing section 25 and the second housing section 27 can be formed as a parallel cylindrical shape in the head section 21.

Moreover, the inner space 26a the first housing section 25 and the first inner space 23a of the head section of 21 are in communication with each other by the vent hole 31 formed in a boundary portion, and in addition, the inner space 28a of the second housing section 27 and the second inner space 23b of the head section 21 are also in communication with each other through the vent hole 32 formed in a boundary portion.

The inner spaces 26a, 28a of the first housing section 25 and the second housing section 27 are formed separate spaces from one another, and when the fill limit vent valve 20 of the various embodiments is mounted on the urea tank, the first housing section 25 and the second housing section 27 are inserted long into the urea tank 11 at the upper mounting position of the urea tank 11.

Floaters 29, 30 are disposed in each of the inner spaces 26a, 28a of the first housing section 25 and the second housing section 27, and the floaters 29 and 30 vertically move according to the liquid level height of urea introduced through the inflow holes 26b, 28b to open and close the vent holes 31, 32 located at the upper end of each housing section.

Further, the inflow holes 26b, 28b, into which urea and air can flow from the interior of the urea tank 11, are formed in the first housing section 25 and the second housing section 27 at different heights, and the inflow hole 26b of the first housing section 25 is formed so as to be positioned at a lower height than the inflow hole 28b of the second housing section 27.

At this time, the inflow hole 26b of the first housing section 25 is formed at a height that allows the urea introduced through the inflow hole 26b to raise the floater 29 of the first housing section 25 to a position blocking the vent hole 31, when the urea of the defined rated capacity is filled in the urea tank 11.

Furthermore, the inflow hole 28b of the second housing section 27 is formed to have a smaller size than the inflow hole 26b of the first housing section 25.

The operating state of the fill limit vent valve according to the present invention will be described below.

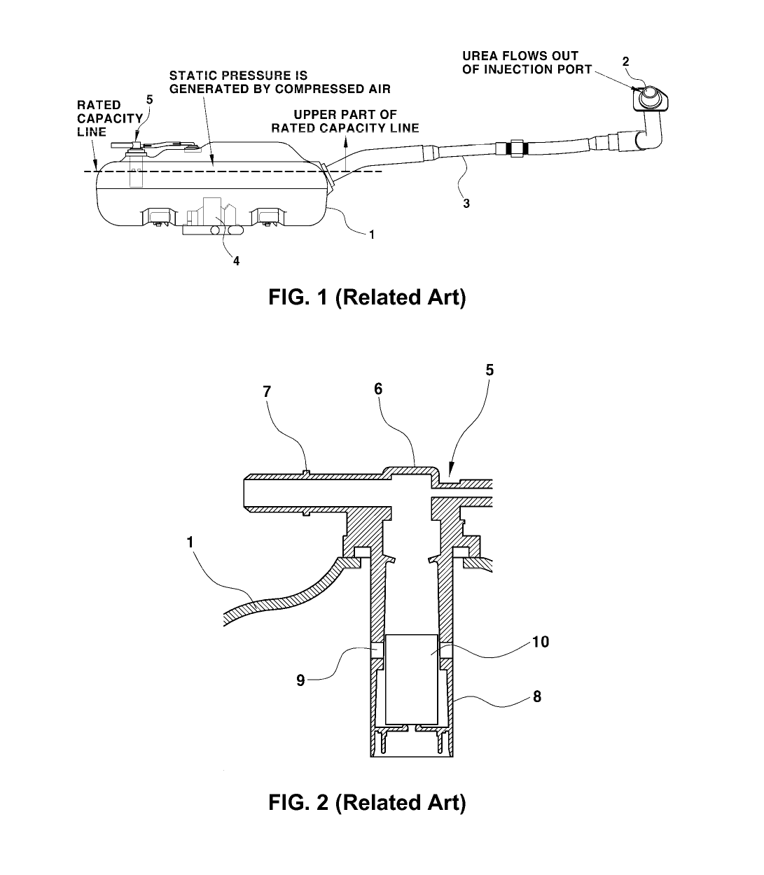

After inserting the injection gun into the injection port (e.g. reference numeral 2 in FIG. 1), the urea is injected using the injection gun through the user injection port, when urea of the rated capacity is filled within the urea tank 11, primarily, the urea flows into the inner space 26a through the inflow hole 26b of the first housing section 25.

At this time, the first floater 29 of the housing section 25 rises to block the vent hole 31, and thereafter, there is a state where the urea is not injected any more into the urea tank 11 through the urea injection port, that is, a primary shut-off state of the fill limit vent valve 20.

In the shut-off state, since the inflow hole 28b of the second housing section 27 is at a position higher than a urea liquid level position (rated capacity line height) in the urea tank 11, air can flow in through the inflow hole 28b of the second housing section 27.

That is, in the shut-off state in which the urea is not injected into the urea tank 11, the upper space of the urea liquid level in the urea tank 11 is in a state of being connected to the outside (atmosphere) through a route of the inflow hole 28b of the second housing section 27 and its inner space 28a, the vent hole 32, the second inner space 23b of the head section 21, the connection passage 33, the first inner space 23a of the head section 21, and the exhaust port 22. Air in the urea tank 11 can be discharged to the outside through this path.

Thus, the urea of rated capacity is filled in the urea tank 11 and the urea is not injected any more, and since the air in the urea tank 11 can be discharged to the outside through the route, the static pressure due to the compressed air does not occur at the upper part of the urea liquid level in the urea tank.

If the static pressure due the compressed air does not occur in this manner, even the injection gun is pulled out of the urea injection port of the vehicle after filling of the rated capacity, the urea does not flow out through the urea injection port.

It is possible to consider that the urea inside the urea tank can be further filled as much compared to the rated capacity when air of the upper part of the urea liquid level in the urea tank 11 is released to the outside in the fill limit vent valve of the present invention described above. However, the amount the urea injected into the urea injection port through the injection port is actually much greater than the amount of air flowing out through the primary shut-off, the urea injected at this time inversely rises through the urea line (e.g. reference numeral 3 in FIG. 1) and the injection port (e.g. reference numeral 2 in FIG. 1).

However, since a sensor is attached to the injection gun, the urea raised through the injection hole is detected through the sensor to immediately shut off the supply of the urea by the injection gun before the urea flows out of the injection port.

In particular, since the size of the inflow hole 28b of the second housing section 27 is smaller than size of the inflow hole 26b the first housing section 25, and the inner diameter of the connection passage 33 is small, only a small amount of air enough to be able to eliminate the static pressure in the urea tank 11 is discharged through the second inner space 23b of the head section 21, the connection passage 33, the first inner space 23a of the head section and the exhaust port 22 via the second housing section 27.

Thus, since the amount the urea injected by the injection gun is greater than the amount of air discharged through the exhaust port 22 in the primary shut-off, the automatic shut-off of the supply of the urea through the sensor detection can be performed. Accordingly, it is possible prevent a phenomenon in which the urea flows out of the injection port due to the over-injection, and especially, since the static pressure is not generated in the urea tank 11 by the air discharge after filling of the rated capacity, even if the injection gun is pulled out of the injection port, it is possible to solve the problem in which the urea flows out due to the static pressure as in the related art.

The inner diameter of the connection passage 33 is important in the fill limit vent valve 20 of the present invention, and if the excess air discharged through the second housing section 27 too easily moves through the connection passage 33 and is discharged through the exhaust port 22, even after filling of the rated capacity, the urea cannot rise to a level that can perform the sensor detection through the urea line and the injection port, and excessive urea can be filled in the urea tank 11.

Thus, the connection passage 33 is preferably formed to have an inner diameter of 3 to 4 mm, and more preferably, it can be formed to have an inner diameter of 3.5 mm.

If the inner diameter of the connection passage 33 is less than 3 mm, there is a problem in which air cannot move at a desired amount and rate to the first inner space 23b from the second inner space 23a of the head section 21 enough to be able to eliminate the static pressure in the urea tank 11.

Further, if it exceeds 4 mm, since air is discharged through the exhaust port 22 by moving too easily, there is a problem in which even after filling of the rated capacity, the urea cannot rise to a level that can perform the sensor detection through the urea line and the injection port, and the excess urea can be filled in the urea tank 11.

It has been experimentally verified that there is not any problem when the inner diameter of the connection passage is set to 3.5 mm through a conventional test.

Furthermore, when the urea is injected using an injection gun sensor having no sensor or using a urea injection mechanism having no other containers or sensors other than the injection gun to which a senor is attached, it is not possible to automatically prevent the over-injection (over-filling) of the urea through the detection of the sensor.

Therefore, as described above, when the urea is filled into the urea tank 11 as much as the limit capacity line exceeding the rated capacity line under the urea injection conditions incapable of performing the automatic supply shut-off through the sensor, the floater 30 inside the second housing section rises by the urea introduced through the inflow hole 28b of the second housing section 27 to block the vent hole 32. Thus, the additional injection of the urea is prevented (secondary shut-off, i.e., the complete shut-off of the fill limit vent valve is performed), and the problem of urea overflowing through the injection port is prevented.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A fill limit vent valve for a urea tank of a vehicle, comprising:
a head section having a first inner space, a second inner space and an exhaust port for discharging air flowing into the first inner space;
a first housing section and a second housing section integrally formed in the head section, the first and second housing sections each having an inflow hole formed so that air and urea flow into an inner space of the respective first and second housing sections in the urea tank, and positioned by being inserted into the urea tank;
a floater disposed in the inner space of the first housing section so as to vertically move according to a liquid level height of the urea introduced from the urea tank through each inflow hole and configured to open and close a vent hole between the first housing section and the head section according to a vertical movement position;
a vent hole formed to allow communication between the first inner space of the head section and the inner space of the first housing section, and between the second inner space of the head section and the inner space of the second housing section, respectively; and
a connection passage provided to allow the inner space and the second space of the head section to communicate with each other,
wherein the inflow hole of the first housing section is formed at a height lower than the inflow hole of the second housing section.

2. The fill limit vent valve for the urea tank of the vehicle of claim 1, further comprising:
a floater disposed in the inner space of the second housing section to vertically move according to the liquid level height of the urea introduced from the urea thank through the inflow hole, and configured to open and close the vent hole between the second housing section and the head section according to the vertical movement position.

3. The fill limit vent valve for the urea tank of the vehicle of claim 1, wherein the head section includes a flange that is fastened or fixedly coupled to an outer surface of the urea tank.

4. The fill limit vent valve for the urea tank of the vehicle of claim 3, wherein the head section is fixed to a urea tank upper portion, and the first housing section and second housing section are formed to extend integrally with the head section so as to be inserted to an inside in the urea tank upper portion.

5. The fill limit vent valve for the urea tank of the vehicle of claim 1, wherein the inflow hole of the first housing section is formed at a height that allows the inflow of the urea enough to raise the floater to a vent hole blocking position inside the first housing when the urea of a defined rated capacity is filled in the urea tank.

6. The fill limit vent valve for the urea tank of the vehicle of claim 1, wherein the inflow hole of the second housing section has a smaller size than the inflow hole of the first housing section.

7. The fill limit vent valve for the urea tank of the vehicle of claim 1, wherein the connection passage has an internal diameter of 3.5 mm.

8. The fill limit vent valve for the urea tank of the vehicle of claim 1, wherein the connection passage has an inner diameter of 3 mm to 4 mm.

9. The fill limit vent valve for the urea tank of the vehicle of claim 1, wherein the head section is fixed to a urea tank upper portion, and the first housing section and second housing section are formed to extend integrally with the head section so as to be inserted to an inside in the urea tank upper portion.
